(19) United States
(12) Patent Application Publication
(10) Pub. No.: US 2017/0039359 A1
(43) Pub. Date: Feb. 9, 2017

(54) ELECTRONIC DEVICE CONTROLLING AND USER REGISTRATION METHOD

(71) Applicant: MEDIATEK INC., Hsin-Chu (TW)

(72) Inventors: Tien-Ju Yang, Taichung City (TW); Yu-Pao Tsai, Kaohsiung City (TW); Dan Luo, Shaoshan, Hunan Province (CN); Tsung-Te Wang, Taipei City (TW); Che-Kuang Lin, New Taipei City (TW); Yu-Ting Chen, Taipei City (TW); Shaw-Min Lei, Hsinchu County (TW); Shu-Fan Wang, Miaoli County (TW)

(21) Appl. No.: 15/305,101

(22) PCT Filed: Jun. 10, 2014
(86) PCT No.: PCT/CN2014/079611

§ 371 Date: Oct. 19, 2016

(51) Int. Cl. G06F 21/32; G06F 21/34

(52) U.S. Cl. CPC G06F 21/32; G06F 21/34

(57) ABSTRACT

An electronic device controlling method and a user registration method are provided. In the electronic device controlling method, when a target device receives a first and a second control commands which are identical, but performed by different users simultaneously or separately, the target device performs a first predetermined operation based on an identity of the user performing the first control command, and performs a second predetermined operation based on an identity of the user performing the second control command. In the user registration method, a user registered identity model corresponding to a user to be registered is established according to identity information of the user, and is mapped to a user profile comprising a relationship between the control commands and the predetermined operations. By acquiring the registered information, the target device is able to perform the user dependent operations.

### TECHNICAL FIELD

The present application relates to an electronic device controlling method and a user registration method, and particularly relates to an electronic device controlling method for controlling an electronic device according to identify information of a user and a user registration method that can register to an electronic device via simple steps.

### BACKGROUND

A user always utilizes a control command (e.g., voice, a gesture, a head turning) to control an electronic device. However, the electronic device can only perform user independent operations according to the control command.

FIG. 1 is a schematic diagram illustrating an electronic device performs a user independent operation for related art. As depicted in FIG. (a) of FIG. 1, the electronic device 100 (e.g., a TV, a mobile phone) receives a first control command CMD_1 from a first user U_1, and the electronic device 100 performs a first predetermined operation PO_1 based on the first control command CMD_1. In FIG. (b) of FIG. 1, the electronic device 100 receives a first control command CMD_1 from a second user U_2, and the electronic device 100 also performs the identical first predetermined operation PO_1 since it receives the same first control command CMD_1. That is, even the electronic device 100 receives control commands from different users, the electronic device 100 will perform the same operation if the received control commands are the same. In other words, the operations performed by the electronic device 100 are user-independent.

### SUMMARY

Therefore, one objective of the present application is to provide an electronic device controlling method to control a target device to perform a user dependent operation.

Another objective of the present application is to provide a user registration method such that a user can register to a target device via simple steps.

One embodiment of the present application discloses an electronic device controlling method for controlling a target device, which comprises: (a) receiving a first control command from a first user; (b) detecting identity information of the first user; (c) determining if the first user is registered via comparing the identity information of the first user with one or more registered identity models; (d) retrieving a first user profile corresponding to the first user if the first user is determined to be registered; and (e) controlling the target device to perform a first predetermined operation according to the first user profile.

Another embodiment of the present application discloses an electronic device controlling method, which comprises: receiving a first control command and a second control command performed by different users simultaneously or separately, wherein the first and the second control commands are identical; in response to the first control command, performing a first predetermined operation based on an identity of a user performing the first control command; and in response to the second control command, performing a second predetermined operation based on an identity of a user performing the second control command.

Still another embodiment of the present application discloses a user registration method for registering a user to a target device, which comprises: (a) obtaining at least one candidate identity information from a sensor; (b) finding a target identity information of the user from the candidate identity information; (c) building a user registered identity model of the user according to the target identity information; and (d) setting a relationship between the registered identity model of the user and a user profile for the user.

In view of above-mentioned embodiments, a user can control the target device to perform user dependent operations according to the control method. Additionally, the user can register to a target device via simple steps.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram illustrating an electronic device performs a user independent operation for related art.

FIG. 2 is a schematic diagram illustrating a target device performs a user dependent operation according to one embodiment of the present application.

FIG. 3-FIG. 4 are examples for how to perform the user dependent operation as shown in FIG. 2, according to embodiments of the present application.

FIG. 5 is a flow chart illustrating an electronic device controlling method according to the embodiments in FIG. 3 and FIG. 4 of the present application.

FIG. 6-FIG. 10 are examples for registering an user to a target device according embodiments of the present application.

FIG. 11 is a flow chart illustrating a user registration method according to the embodiments in FIG. 6 to FIG. 10 of the present application.

FIG. 12 is a block diagram illustrating a target device according to one embodiment of the present application.

### DETAILED DESCRIPTION

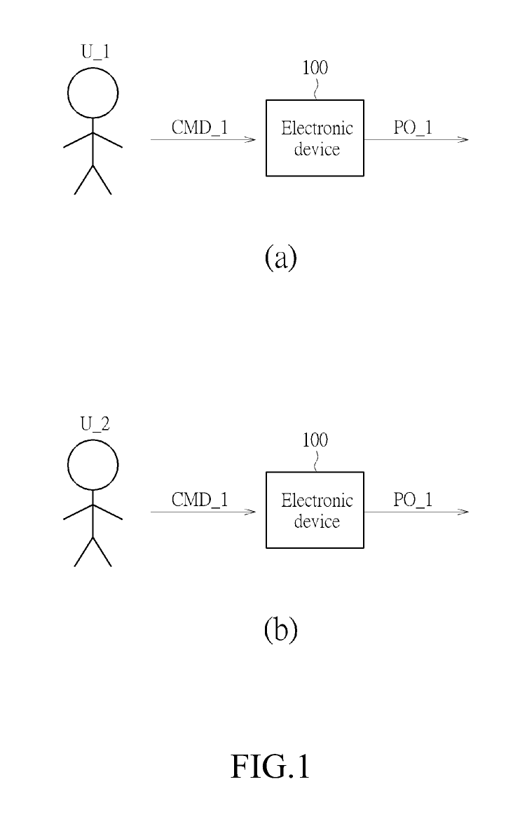

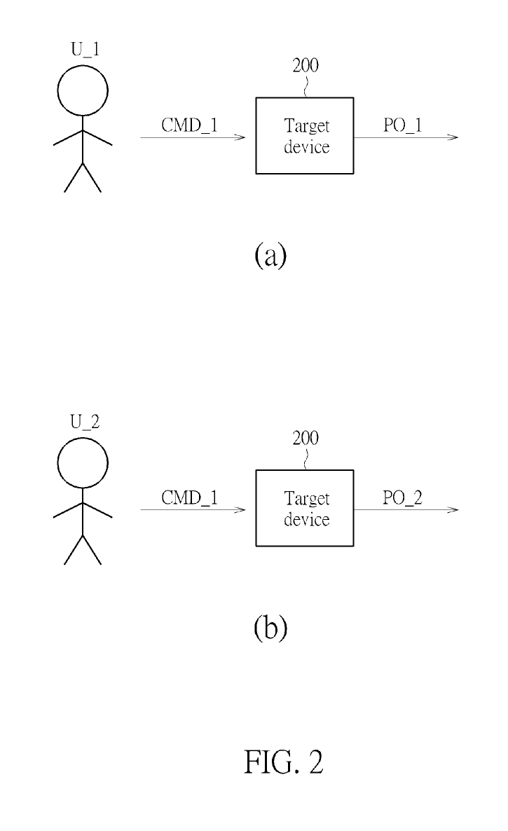

FIG. 2 is a schematic diagram illustrating a target device performs a user dependent operation according to one embodiment of the present application. As depicted in FIG. (a) of FIG. 2, the target device 200 (e.g., a TV or a mobile phone, but is not limited thereto) receives a first control command CMD_1 from a first user U_1, and the target device 200 performs a first predetermined operation PP_1 based on the first control command CMD_1. In FIG. (b) of FIG. 2, the target device 200 also receives the first control command CMD_1 from a second user U_2, but the target device 200 performs a second predetermined operation PO_2 rather than the first predetermined operation PO_1 as shown in FIG. 1. The target device 200 may perform different operations even though the target device 200 receives the same control commands from different users. That is, the operations performed by the target device 200 are user-dependent.

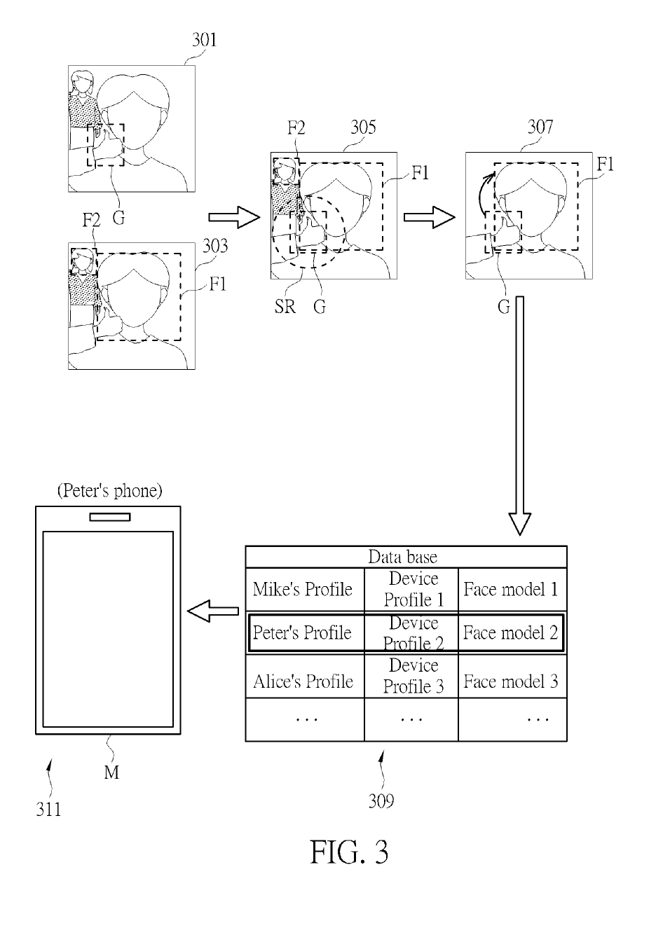

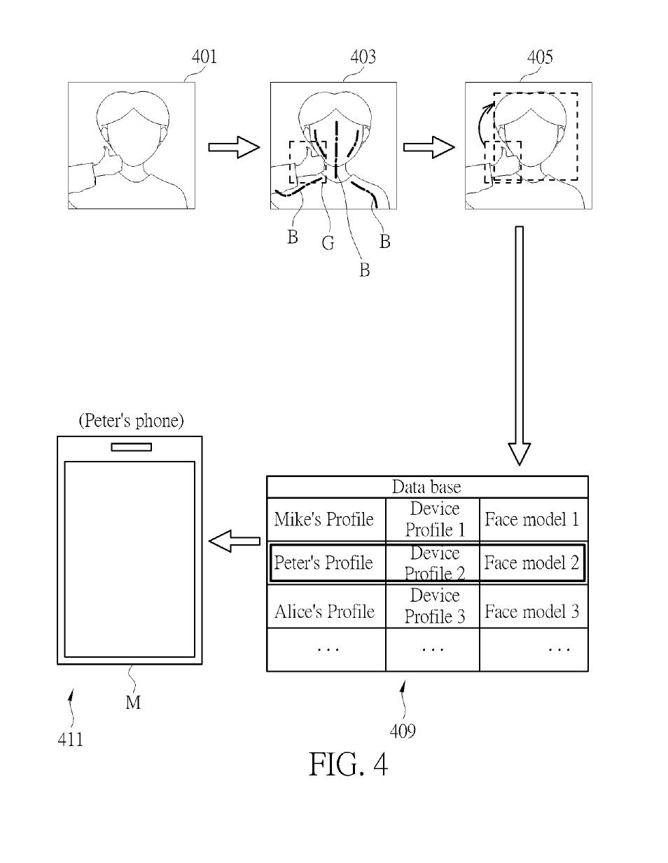

Several embodiments are provided as below to explain how to reach the actions depicted in FIG. 2. Please note, in the embodiments of FIG. 3 and FIG. 4, a database for storing user profiles and face models are pre-stored in the target device for registered users. Alternatively, the database may reside on the local device of the registered user (e.g., user's mobile phone) or in the cloud storage, and is fetched by any target device when necessary. By this way, the user can register with one or more target devices by one-time registration. The manner of building the face model and the registration procedure will be described later.

Please refer to FIG. 3, an image comprising a gesture region G associated with a gesture performed by someone is captured by the target device in the step 301. In the step 303, at least one face region is detected by the target device (in this example, two face regions F1 and F2 are detected). Please note the order of the steps 301, 303 are not fixed. The step 301 can be the first step or be a step after the step 303. In the step 305, the target device selects one of the at least one face region within the image according to a relative distance between the gesture region G and each face region. For example, the relative distance is a distance from the center of the gesture region G to the center of each of the face regions F1 and F2. The face region corresponding to the shortest relative distance will be selected by the target device. Alternatively, the target device may select the face region having a center within a predetermined search region SR, wherein the centers of the predetermined search region SR and the gesture region G are overlapping. However, if each face region center is not within the predetermined search region SR, the target device selects a face region having a center closest to the predetermined search region SR. In this embodiment, the face region F1 is selected and associated with the gesture region G.

The target device may identify the user performing the gesture after the gesture has been detected. Alternatively, the target device may identify each user in a predetermined range of the target device before detecting any gesture, and in this examples, the user identity of each user in front of or near the target device may be determined only according to the face region(s) acquired in the step 303 but not according to the gesture region G. That is, the step 305 is optional in this case.

In the step 307, the target device obtains the facial data from the selected face region F1. In the step 309, the facial data is compared with the face models (e.g., the face models 1to 3) stored in the target device to determine the identity of the user. If the user has registered to the target device, the user profile corresponding to the user can be acquired from the database. For example, assuming that the user is Peter and has already registered to the target device. Peter's user profile will be acquired by the target device once the user is determined to be Peter according to the facial data, as shown in the step 309. The user profile comprises various user information. For example, the user profile comprises the relationship between the control commands and the predetermined operations. In one example, in Peter's user profile, a “thumbs up” gesture is associated with an operation of switching the TV channel to channel 52, but in Alice's user profile, the identical “thumbs up” gesture is associated with an operation of switching the TV channel to channel 30.

Besides the user profile, the database may further comprise the device profiles for different client devices (e.g., Device Profile 1, Device Profile 2, Device Profile 3 in FIG. 3), which may comprises device information such as the IP address, the mac address, the name and the type of the device. Furthermore, the relationship between the user and the client device may be maintained in the database. For example, according to the associated device profile 2 and the Peter's profile, the target device may identify the client device of Peter is the mobile phone M, as shown in the step 311.

After the user's user profile is acquired, the target device performs a predetermined operation according to the user profile. The predetermined operation may simply relate to the target device. Alternatively, the predetermined operation may relate to the target device as well as one or more other devices. However, the type of the predetermined operation is not limited thereto.

For example, the predetermined operation may include displaying predetermined content on the target device. The operation of displaying predetermined content on the target device can be, for example, displaying video or audio data.

In one example, if the target device is a TV, information filtering function such as “Parent control” can be performed via above-mentioned embodiments. For example, if a channel switching command is received, the displayed selectable channels are different corresponding to different users. In another example, if a turning on command, an unlock command or a launching application command is received, the content (e.g., the arrangement of icons, buttons and software input panel) for the user interface changes corresponding to different users.

In another example, if several users are watching TV and one of the user's mobile phone receive a call, the TV will display a message to tell the users whose mobile phone is receiving a call. If the owner of the mobile phone receiving the call performs a predetermined gesture, the owner can answer the call via the TV. In such example, only the owner can answer the call via performing the predetermined gesture. Other users cannot answer the call even if they perform the same gesture.

In another example, when the user desires to read or send a message via the TV, he can only read or send the message by his account since he must be identified first. By this way, the security for each person's message is raised.

Alternatively, the predetermined operation may include performing a function of a social network such as a community website, a shopping network, or any online service via the first user's account. The operation of performing a function of a community website via the first user's account can be, for example, clicking “like” to an article via the user's account for the community website.

In another embodiment, the target device may perform a predetermined operation such as sharing data with a client device. The client device can be the user's client device, which is connected to the target device (such as Peter's client device M in the step 311). The client device which the target device shares data with can be assigned when the user registers to the target device. For example, the device profile in the step 309, which indicates the relation between the user and the client device, is acquired when the target device shares data with a client device. The client device can be any electronic device, for example, a mobile phone or a laptop.

However, please note the target device is not limited to share data with a particular user's client device. The target device can share data with any client device. For example, the user can perform a gesture to trigger the sharing operation and then select a client device in a predetermined range of the target device such that the target device can share data with the selected client device. More specifically, the target device may act as a data sharing center. One user may share images from his mobile phone (i.e., the client device) to the target device, and the other user may uses gesture to download the image to his mobile phone from the target device. In another example, if a TV (the target device) takes a picture of the user, and the user can control the target device to share his image with other client devices, after the user is identified by the target device. In yet another example, when the target device detects a specific gesture performed by a registered user, the target device takes a snapshot of a screen and consults the device profile corresponding to the registered user, so as to transmit the snapshot to the client device of the user.

Other methods can be applied to determine who the user performing the gesture is. As shown in FIG. 4, in step 401, the target device retrieves an image of the user performing the gesture. In step 403, the target device selects one of at least one face region within the image by analyzing a human skeleton B based on a gesture region G associated with the gesture. In step 405, the target device obtains the facial data from the selected face region. After the facial data is acquired, steps 409 and 411 are performed. Details of steps 409 and 411 are the same or similar to the steps 309 and 311 in FIG. 3, thus are omitted for brevity here.

Please note the scope of the present application is not limited to the embodiments depicted in FIG. 3 and FIG. 4. For example, the hand gesture illustrated in FIG. 3 and FIG. 4 can be replaced by other control commands such as a voice command, an eye gaze, a head turning or a body gesture. These commands can be input to the target device via an input device or without an input device. For more detail, the user may directly touch or press an input device (e.g., a touch screen, a mouse, a keyboard, or a remote controller) to input a control command. Alternatively, the user may use an input device to input a control command without direct contact of the input device (e.g., hovering over a touch screen). The command without using an input device can be, for example, the voice command, or a body motion command supported by a non-touch 3D motion tracking technique.

Additionally, in the foregoing embodiments, the facial data of the user can be replaced by other identity information. For example, the identity information can be biometric information such as: a fingerprint, a palm print, iris data, a skeleton structure, a voice print or a combination thereof. Alternatively, the identity information can be obtained by a username and password authentication, an identification card or a signature. Accordingly, the above-mentioned face model also changes to another identity model corresponding to the identity information. For example, if the identity information is a fingerprint, the identity model is a fingerprint model rather than a face model. Similarly, if the identity information is a skeleton structure, the identity model is a skeleton model rather than a face model.

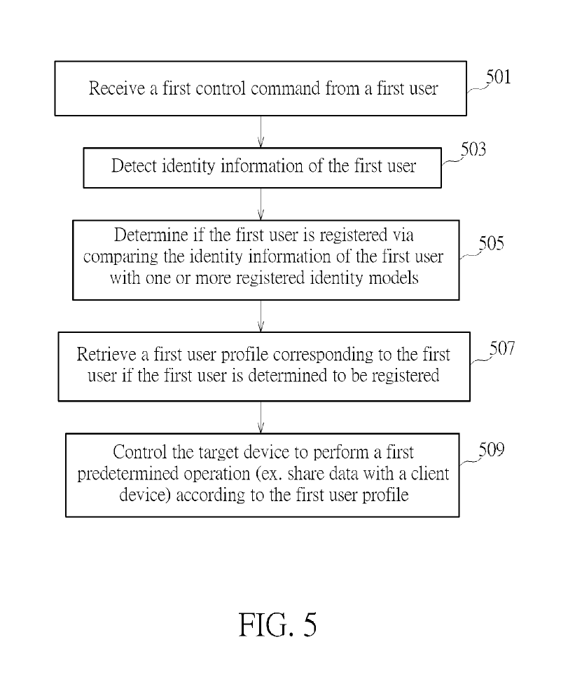

In view of above-mentioned description, an electronic device controlling method can be acquired according to the embodiments depicted in FIG. 3 and FIG. 4. FIG. 5 is a flow chart illustrating an electronic device controlling method according to the embodiments of the present application. FIG. 5 comprises the following steps:

Step 501

Receive a first control command (e.g., a hand gesture) from a first user.

Step 503

Detect identity information (e.g., facial data) of the first user.

Step 505

Determine if the first user is registered via comparing the identity information of the first user with one or more registered identity models (e.g., a face model).

In one embodiment, if the first user is determined to be unregistered, the target device performs a default operation which is user-independent. Alternatively, the target device may request the first user to register through a registration method, as will be described later.

As above-mentioned, the registered identity models may be pre-stored in the target device. However, the registered identity models may be pre-stored in a client device such as the registered user's device, or in a cloud storage, and will be acquired by the target device when necessary.

Step 507

Retrieve a first user profile corresponding to the first user if the first user is determined to be registered.

In one embodiment, the corresponding device profile is also retrieved in the step 507, thereby the first user can control the target device to share data with the client device based on the device profile.

Step 509

Control the target device to perform a first predetermined operation (e.g., share data with a client device) according to the first user profile.

Please note the embodiments depicted in FIG. 3 and FIG. 4 are not limited to perform the operation depicted in FIG. 2. Also, the operation in FIG. 2 is not limited to be performed by the embodiments depicted in FIG. 3 and FIG. 4. Additionally, please note the scope of the present application is not limited to that the target device performs different functions while receiving the same control command from different users. The target device can still perform the same functions while receiving the same control command from different users. Accordingly, the operation illustrated in FIG. 2 can be summarized as: a controlling method of an electronic device, comprising: receiving a first control command and a second control command performed by different users simultaneously or separately, wherein the first and the second control commands are identical; in response to the first control command, performing a first predetermined operation based on an identity of a user performing the first control command; and in response to the second control command, performing a second predetermined operation based on an identity of a user performing the second control command. The first predetermined operation and the second predetermined operation can be identical or different.

In one embodiment, it is assumed that three users are registered with a target device and the user profiles of the three users all indicate that the predetermined operation corresponding to a specific hand gesture is to send a snapshot of the screen of the target device to the corresponding client device. Once the target device receives the specific hand gestures at the same time from these three users, the target device sends the snapshot to the client device of each user accordingly.

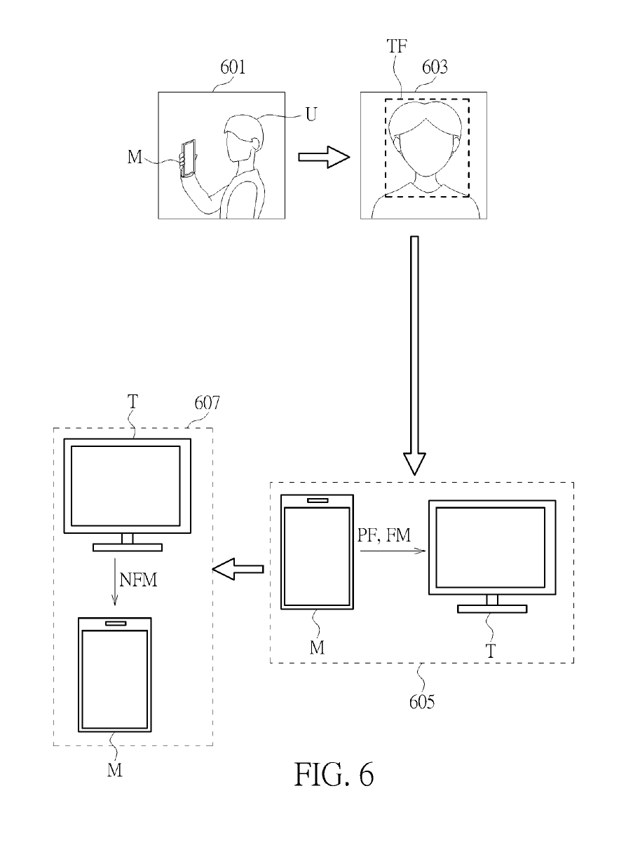

In the following, several examples are provided to explain how a user and/or a client device register for a target device, and how the face model, the user profile are acquired. FIG. 6-FIG. 10 are examples for registering a user and the user's client devices to a target device according embodiments of the present application.

In the step 601 of FIG. 6, the user U captures an image for himself/herself via a client device M (e.g., a mobile phone), which has at least user profile stored therein. Accordingly, the client device M acquires an image comprising at least one candidate face (i.e. more than one face might be in the image). In the step 603, a target face TF is founded from the candidate face(s). The target face can be, for example, the only one face in the image, the largest face in the image, the selected face in the image, or an unknown face in the image, but not limited. In this example, the face in the image is the only one and the largest face, thus is selected as the target face TF. Also, in the step 603, a face model is generated according to the target face TF by the client device M. In the step 605, the user profile PF and the face model FM are transmitted from the client device M to the target device T. Via above-mentioned steps, the face model and the user profile of the user U are associated and stored in both the client device M and the target device T, thus the user U can carry on the user profile and the face model via the client device M and can register for other target devices via the client device M. In one embodiment, the face model FM and the user profile PF are related with a device profile of the client device M, and the device profile is also transmitted to the target device T. By this way, the client device M is registered as the client device for the user U.

After the face model is stored in the target device T, the target device T may online update the face model and send back the new face model NFM to the client device M, as illustrated in the step 607. Via such step, the face model can be more complete. However, the step 607 is only optional and can be removed.

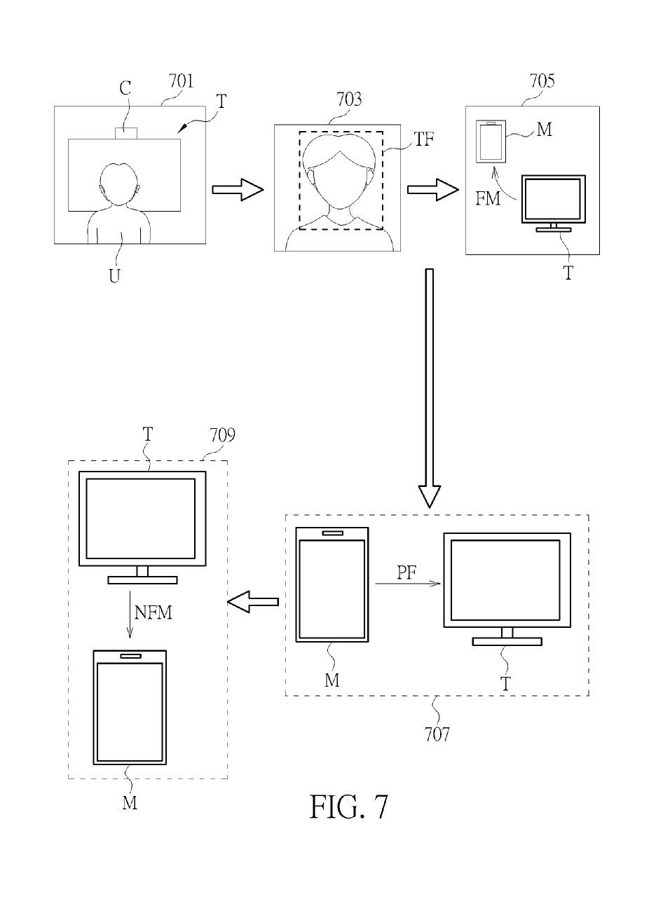

FIG. 7 is another example for registering a user to a target device according one embodiment of the present application. In the step 701, the user U captures an image for himself/herself via a camera C mounted on the target device T. The image comprises at least one candidate face. The step 703 is similar with the step 603, finds a target face TF from the candidate face (s) and generates a face model according to the target face TF by the target device T. In the step 705, a client device is selected (in this example, still the client device M for the user U), and the target device T transmits the face model FM to the client device M. In one embodiment, a user interface is displayed on the target device for the user to select a client device. The user profile PF can also be transmitted from the client device M to the target device T, such as the step 707, but not limited. The same as the embodiment in FIG. 6, in one example the user profile PF is related with a device profile of the client device M, and the device profile is also transmitted from the client device M to the target device T. By this way, the client device M is registered as the client device for the user U. The steps 709 is the same as the step 607, thus the description thereof are omitted for brevity here.

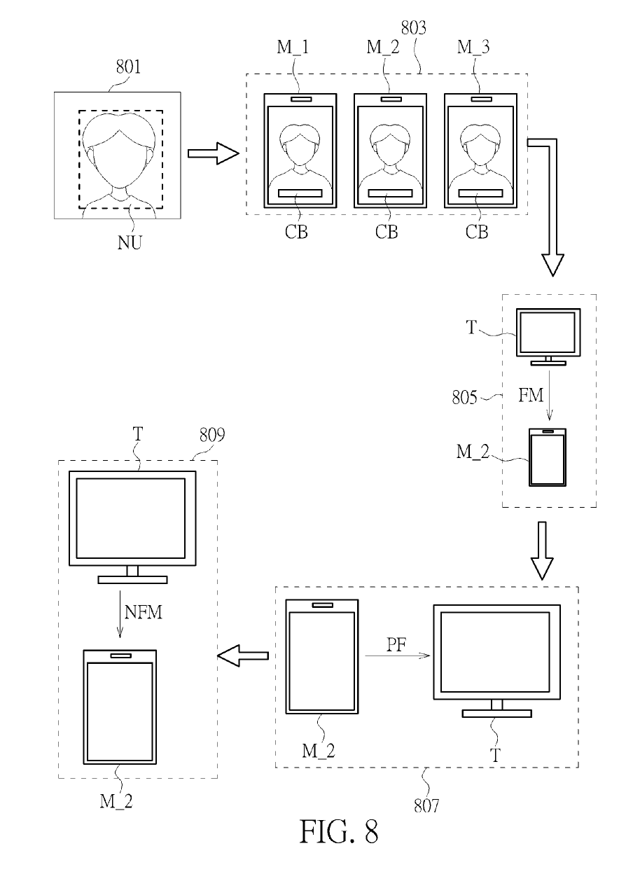

FIG. 8 is another example for registering a user to a target device according one embodiment of the present application. In the step 801, a user NU who does not register to the target device is detected while the image of the user NU is captured by a camera mounted on the target device. Additionally, the face model for user NU is also generated according to the image by the target device. In the step 803, the target device detects at least one non-registered client device in a predetermined range thereof (client devices M_1, M_2 and M_3 in this example), and transmits the image captured in the step 801 to the non-registered client devices M_1, M_2, and M_3. While the non-registered client devices M_1, M_2, and M_3 receive the image, a confirm button CB is displayed thereon. If any user presses the confirm button (in this example, the confirm button of the client device M_2 is pressed) to confirm the image captured in the step 801 is his/her image, the target device transmits the face model FM to the non-registered client device M_2 at which the image is confirmed, as depicted in the step 805. The step 803 can be regarded as a step of searching a target face (the face of the user NU).

In the step 807, the client device M_2 transmits the user profile PF to the target device T. As above-mentioned, the client device M_2 may transmit it's device profile to the target device T as well. By this way, the user can easily register to a target device which he or she has not registered before, and the target device T can automatically inform a user that he or she has not registered yet. The step 809 is the same as the step 607, thus is omitted for brevity here.

Please note, although a confirm button CB is provided for the user to confirm. Other mechanisms can be applied for the user to confirm. For example, the user can use a voice command or a gesture command to confirm. Additionally, the step 801 can be replaced by: while a certain gesture is detected and the identity of the user NU performing the gesture cannot be recognized, the target device captures the image of the user NU for subsequent registration process. Similar variation should all fall in the scope of the present application.

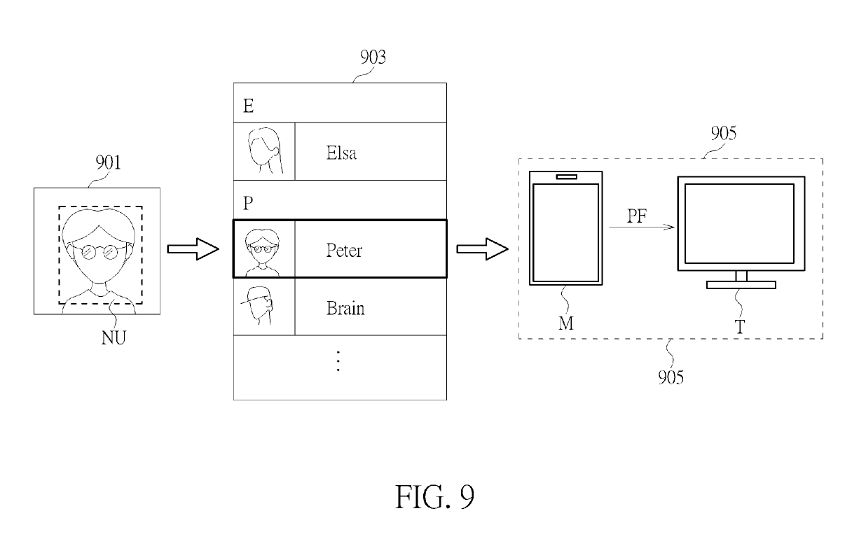

FIG. 9 is still another example for registering a user to a target device according one embodiment of the present application. In the step 901, a user NU not registered with the target device is detected by the target device and the image of the user NU is captured so as to generate the face model for user NU. In the step 903, the target device searches the face of the user NU in one or more nearby client devices.

For example, the target device searches the face of the user NU in telephone directories stored in the nearby client devices. Or, in another example, the target device searches the face of the user NU in the friend list of an instant messenger installed in the nearby client devices. The step 903 can be regarded as a step of searching a target face (the face of the user NU).

After the target face is found, in the step 905, the client device M comprising the contact list having the target face updates the user profile PF of the user NU to the target device T. For example, if Peter is a non-registered user for a target device, and the target device finds Peter's face in Jean's telephone directory, the user profile for Peter is updated from Jeans' client device (if it is already stored in Jean's client device). Besides, the client device M may transmit it's device profile to the target device T as well. In such embodiment, the face model can be online updated as above-mentioned, but not illustrated here. However, please note such embodiment is not limited to search the face of the user NU in other client device's contact list, the face of the user NU can also be searched in other data region (e.g., an image folder file).

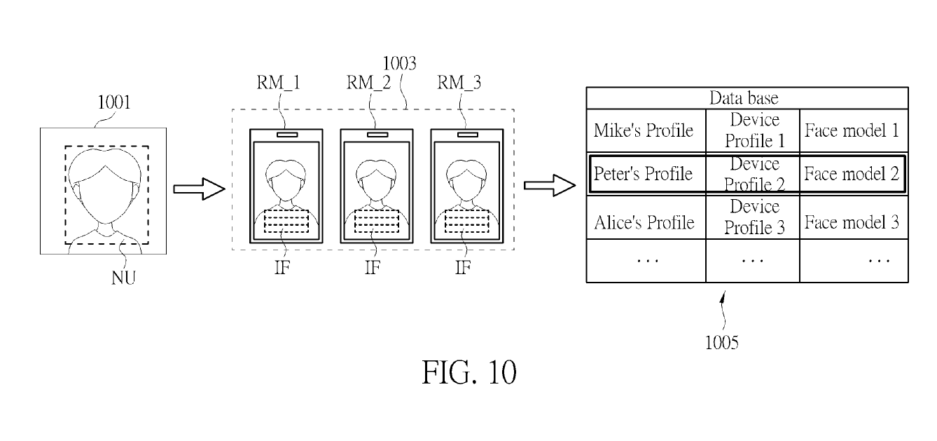

FIG. 10 is still another example for registering a user to a target device according one embodiment of the present application. In the step 1001, a user NU who does not register to the target device is detected by the target device and the image of the user NU is captured. Additionally, the face model for user NU is also generated according to the image by the target device in the step 1001. In the step 1003, the target device detects at least one client device within a predetermined range, and transmits the image to the detected client devices. In this example, the client devices RM_1, RM_2, and RM_3 are the client devices nearby. While the image is received by the detected client devices RM_1, RM_2, and RM_3, an input form IF is displayed on the client devices RM_1, RM_2, and RM_3. By this way, information for the user NU can be input via the client devices RM_1, RM_2, or RM_3. The client device receiving the information of the user NU may build a face model for the user NU. It would be appreciated that the step 1003 may also be regarded as a step of searching a target face (the face of the user NU).

In the step 1005, the user profile is updated according to the information for the user NU input from the client device RM_1, RM_2, or RM_3. In this embodiment, the face model is sent to the target device along with the user profile. Alternatively, the face model may be online updated as above-mentioned. Besides, the client device receiving the information of the user NU may transmit it's device profile to the target device as well.

Please note the facial data of the user can be replaced by other identity information in the embodiments of FIG. 6-FIG. 10. For example, the identity information can be biometric information such as: a fingerprint, a palm print, iris data, a skeleton structure, a voice print or a combination thereof. Alternatively, the identity information can be obtained by a username and password authentication, an identification card or a signature. The above-mentioned face model also changes to another identity model corresponding to the identity information. For example, if the identity information is a fingerprint, the identity model is a fingerprint model rather than a face model. Similarly, if the identity information is a skeleton structure, the identity model is a skeleton model rather than a face model.

Besides the advantage that the user can easily register to a target device, other advantages can be provided based on the embodiments illustrated in FIG. 6-FIG. 10. For example, face models and the user profiles can be stored to the user's mobile phone, such that any target device can acquire the face models or the user profiles from the mobile phone anytime and anywhere. By this way, the step of capturing an image for generating the face model can be omitted.

Furthermore, the command provided by the user can connect to the client device. For example, if John prefers a “thumb up” gesture, he can set his user profile such that the target device will control his client device while John performing the “thumb up” gesture. Similarly, if Jean prefers a “V” gesture, she can set her user profile such that the target device will control her client device while Jean performing the “V” gesture.

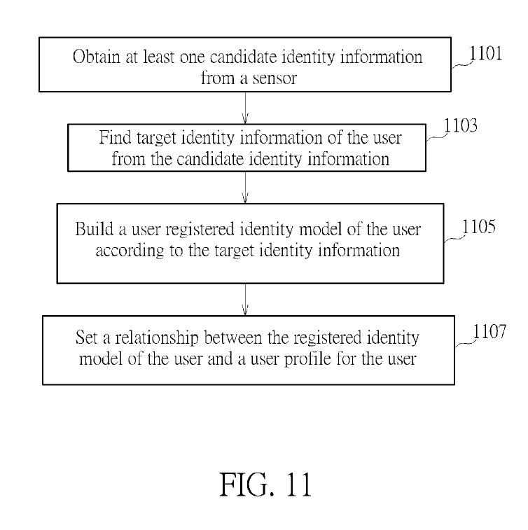

In view of above-mentioned description, a user registration method can be acquired according to the embodiments depicted in FIG. 6-FIG. 10. FIG. 11 is a flow chart illustrating a user registration method according to the embodiments in FIG. 6-FIG. 10 of the present application. FIG. 11 comprises the following steps:

Step 1101

Obtain at least one candidate identity information from a sensor. For example, capture an image comprising at least one candidate face via an image sensor, such as the step 601, 701, 801, 901 and 1001 in the foregoing embodiments. If the candidate identity information is other information besides the facial data, the sensor can be a corresponding sensor such as a finger print sensor, palm line sensor, or a voice recorder.

Step 1103

Find target identity information of the user from the candidate identity information. For example, find a target face such as the steps 603, 703, 803, 903 and 1003 in the foregoing embodiments.

Step 1105

Build a user registered identity model of the user according to the target identity information. For example, build a face model according to the target face such as the steps 603, 703, 803, 903 and 1003 in the foregoing embodiments.

Step 1107

Set a relationship between the registered identity model of the user and a user profile for the user. For example, in the steps 605, 707, 807, 905, and 1005, the user profile is transmitted from the client device to the target device T, and then the relationship between the user profile and the face model are set. Please note the user profile is not limited to be transmitted from the client device to the target device, the user profile may reside on the target device and may be transmitted from the target device to the client device in other embodiments.

Other detail steps can be acquired according to above-mentioned description, thus are omitted for brevity here.

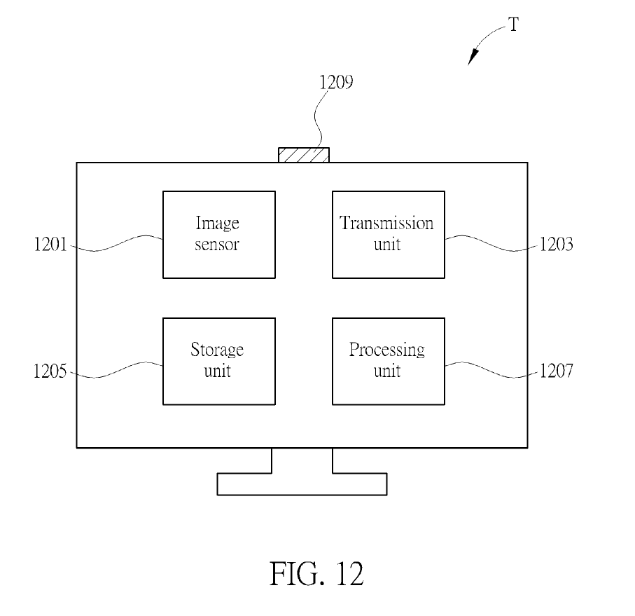

FIG. 12 is a block diagram illustrating a target device/a client device according to one embodiment of the present application. Please note the structure in FIG. 12 is only for example and does not mean to limit the scope of the present application. As illustrated in FIG. 12, the target device T (in this example, a TV) comprises an image sensor 1201, a transmission unit 1203, a storage unit 1205, a processing unit 1207 and a lens 1209. The image sensor 1201 and the lens 1209 can be regarded as a part of a camera. The image sensor 1201 captures an image of the user via the lens 1209. The transceiving unit 1203 is arranged to transmit or receive data such as face models, user profiles or client device profiles. The storage unit 1205 is arranged to stored data such as face models, user profiles, client device profiles and the relationship thereof, or other received data. The processing unit 1207 is arranged to control the operation for the image sensor 1201, the transmission unit 1203 and the storage unit 1205, and perform computation-related tasks. For example, the processing unit 1207 controls the image sensor 1201 and the lens 1209 to capture an image of a user, and then the processing unit 1207 builds the face model. After the target device T receives the user profile and the device profile of a client device through the transmission unit 1203, the processing unit 1207 establishes a relationship between the face model of the user, the user profile and the client device profile, and stores the relationship and these data into the storage unit 1205. Once the target device T detects a gesture from the user, the processing unit 1207 checks the stored relationship and data, such as face models, so as to perform a predetermined operation based on the identity of the user.

Please note the target device is applied as an example to explain an electronic device that can perform the methods provided by the present application. However, the structures depicted in FIG. 12 can also be applied to a client device.

In view of above-mentioned embodiments, a user can control the target device to perform user dependent operations according to the control method. Additionally, the user can register to a target device via simple steps.

Those skilled in the art will readily observe that numerous modifications and alterations of the device and method may be made while retaining the teachings of the invention. Accordingly, the above disclosure should be construed as limited only by the metes and bounds of the appended claims.

1. An electronic device controlling method, for controlling a target device, comprising:
(a) receiving a first control command from a first user;
(b) detecting identity information of the first user;
(c) determining if the first user is registered via comparing the identity information of the first user with one or more registered identity models (;
(d) retrieving a first user profile corresponding to the first user if the first user is determined to be registered; and
(e) controlling the target device to perform a first predetermined operation according to the first user profile.

2. The electronic device controlling method of claim 1, further comprising:
receiving a second control command from a second user;
detecting identity information of the second user;
determining if the second user is registered via comparing the identity information of the second user with the one or more registered identity models;
retrieving a second user profile corresponding to the second user if the second user is determined to be registered; and
controlling the target device to perform a second predetermined operation according to the second user profile;
wherein the first control command and the second control command are identical, but the first predetermined operation and the second predetermined operation are different.

3. The electronic device controlling method of claim 1, wherein the identity information comprises at least one of: a fingerprint, a palm print, iris data, facial data, a skeleton structure and a voice print.

4. The electronic device controlling method of claim 1, wherein the first control command comprises at least one following command: a voice command, a hand gesture, an eye gaze, a head turning, a body gesture.

5. The electronic device controlling method of claim 1, wherein the first predetermined operation comprises at least one following operation: displaying specific content corresponding to the identity information of the first user on the target device, performing a function of an online service via the first user's account, sharing data with a client device.

6. The electronic device controlling method of claim 1, wherein the identity information is facial data, the first control command is a gesture, and the step (b) comprises:
retrieving an image of the first user performing the gesture;
selecting one of at least one face region within the image according to a relative distance between a gesture region associated with the gesture and each face region; and
obtaining the facial data from the selected face region.

7. The electronic device controlling method of claim 1, wherein the identity information is the facial data, the first control command is a gesture, and the step (b) comprises:
retrieving an image of the first user performing the gesture;
selecting one of at least one face region within the image by analyzing a human skeleton based on a gesture region associated with the gesture; and
obtaining the facial data from the selected face region.

8. The electronic device controlling method of claim 1, wherein the electronic device controlling method further comprises a user registering step for registering the first user to the target device before the step (c), wherein the user registering step comprises:
obtaining at least one candidate identity information from a sensor;
finding a target identity information of the first user from the candidate identity information;
building a registered identity model of the first user according to the target identity information; and
setting a relationship between the registered identity model of the first user and the first user profile.

9. The electronic device controlling method of claim 8, wherein the registered identity model of the first user and the first user profile are related with a device profile of a client device.

10. An electronic device controlling method, comprising:
receiving a first control command and a second control command performed by different users simultaneously or separately, wherein the first and the second control commands are identical;
in response to the first control command, performing a first predetermined operation based on an identity of a user performing the first control command; and
in response to the second control command, performing a second predetermined operation based on an identity of a user performing the second control command.

11. A user registration method for registering a user to a target device, comprising:
(a) obtaining at least one candidate identity information from a sensor;
(b) finding a target identity information of the user from the candidate identity information;
(c) building a user registered identity model of the user according to the target identity information; and
(d) setting a relationship between the registered identity model of the user and a user profile for the user.

12. The user registration method of claim 11, wherein the registered identity model of the user and the user profile are related with a device profile of a client device.

13. The user registration method of claim 12, wherein the registered identity model, the user profile, and the device profile related to each other are stored in a storage device and acquired by a plurality of target devices to provide a one-time registration.

14. The user registration method of claim 11,
wherein the step (a), the step (b) and the step (c) are all performed via a client device;
wherein the user profile is stored in the client device, wherein the user registration method further comprises:
transmitting the user registered identity model and the user profile to the target device.

15. (canceled)

16. The user registration method of claim 11,
wherein the step (a), the step (b) and the step (c) are all performed via the target device;
wherein the user registration method further comprises:
(e) selecting a client device by the user; and
(f) transmitting the user registered identity model to the client device selected in the step (e).

17. (canceled)

18. The user registration method of claim 11, wherein the identity information is a facial data and the user registered identity model is a face model, wherein the step (a) captures a image for the user, the step (b) finds a target face from the image, and the step (c) builds the user registered identity model according to the target face.

19. The user registration method of claim 18, wherein the target face is a face meets at least one following condition:
the only one face in the image, the largest face in the image, the selected face in the image, and the unknown face in the image.

20. The user registration method of claim 18, wherein the user is a user not registered to the target device, wherein the user registration method further comprises:
detecting at least one non-registered client device, which is not registered to the target device, in a predetermined range of the target device;
transmitting the image to the at least one non-registered client device; and
transmitting the face model to one of the at least one non-registered client device at which the image is confirmed.

21. The user registration method of claim 18, wherein the user is a user not registered to the target device, wherein the user registration method further comprises:
detecting at least one client device in a predetermined range of the target device;
searching the target face in the at least one client device; and
updating the user profile of the user to the target device from one of the at least one client device which comprises the target face.

22. The user registration method of claim 18, wherein the user is a user not registered to the target device, wherein the user registered identity model generating step further comprises:
detecting at least one client device in a predetermined range of the target device;
transmitting the image to the at least one client device and displaying an input form on the at least one client device; and
updating the user profile of the user to the target device from one of the at least one client device at which user information is input via the input form.
